(19) United States
(12) Patent Application Publication
(10) Pub. No.: US 2014/0161385 A1
(43) Pub. Date: Jun. 12, 2014

(54) Method and Apparatus for Coupling to an Optical Waveguide in a Silicon Photonics Die

(71) Applicant: Telefonaktiebolaget LM Ericsson (publ), (US)

(72) Inventors: Stephane Lessard, Mirabel (CA); Robert Brunner, Montreal (CA); Qing Xu, Montreal (CA)

(73) Assignee: TELEFONAKTIEBOLAGET LM ERICSSON (PUBL), Stockholm (SE)

(21) Appl. No.: 13/708,278

(22) Filed: Dec. 7, 2012

(51) Int. Cl. G02B 6/122; G02B 6/136

(52) U.S. Cl. CPC G02B 6/122; G02B 6/136
USPC 385/14; 264/1.27; 264/1.25

(57) ABSTRACT

This disclosure teaches an optical transposer that provides “passive” alignment between optical waveguides in a silicon photonics die seated within a receptacle that is formed in a body member of the optical transposer and corresponding optical waveguides that are precisely dimensioned and located within the body member via laser scribing. The manufacturing method and optical transposer configuration taught herein allow for essentially automated placement (e.g., seating and gluing) of silicon photonics dies within corresponding optical transposer receptacles, without need for controlling final die alignment/placement as a function of measured optical insertion loss. In particular, such passive alignment is obtained via accurate dimensioning of the receptacles relative to the dies and by precise positioning of the entry points into the receptacles of the optical waveguides that are laser scribed into the body member of the optical transposer.

### TECHNICAL FIELD

The present invention generally relates to optical waveguides and coupling, and particularly relates to coupling to an optical waveguide in a silicon photonics die.

### BACKGROUND OF THE INVENTION

In a silicon photonic circuit, the silicon serves as the optical medium. For example, an optical waveguide may be formed in a silicon layer and light may be confined to the optical waveguide by cladding the silicon material on its top and bottom with silicon dioxide (SiO2), for example.

FIG. 1 illustrates an example silicon photonics die 10 (“die 10”). The die 10 has an exterior die edge 12 along a vertical face of the die 10, which includes an optical waveguide 14. The centerline or optimal alignment point for the optical waveguide 14 is denoted by line 16, and is also referred to as the (X2, Z2) point within the X, Y, Z dimensional references of the die 10. Merely as an example configuration for discussion, the die 10 may have electrical contacts—not shown—for converting input electrical signals into corresponding light emissions transmitted through the optical waveguide 14, or for converting light coupled into the optical waveguide into corresponding output electrical signals.

Transmitting or receiving light through the optical waveguide generally requires precise alignment of an optical fiber or other external optical coupling medium or element with the optical waveguide 14. In this regard, the critical alignment point of the optical waveguide 14 may be referred to as the (X2, Z2) point, where the die 10 has X, Y, and Z dimensions of (X1, Y1, Z1). With this notation, it will be appreciated that (X2, Z2) defines a point within the die face running along the exterior edge 12 of the die 10. It is known to manufacture such dies with X1, Y1, and Z1 dimensions in the range of 100-250 μm. In turn, the cross-sectional dimensions of single-mode silicon waveguide is in the range of a few hundred nanometers. Of course, these dimensions should be understood as non-limiting examples.

With such small dimensions involved, coupling to the die 10 in a manner that achieves and maintains accurate optical alignment with the die's waveguide(s) is difficult. It is known to use hetero-structure like grating couplers or butt coupling at the edge 12 of the die 10, but such usage does not overcome the problems that are inherent in fixing the alignment of a single-mode optical fiber having a minimum diameter of typically 8000 nm or 9000 nm to the (X2, Z2) optical alignment point of the optical waveguide 14.

Indeed, “active” alignment is a known technique for obtaining acceptable insertion loss between the optical waveguide 14 and an optical fiber coupled to it. In manufacturing processes based on active alignment, the alignment process is controlled according to live or ongoing direct or indirect measurements of insertion loss. Such approaches can be understood as a “closed loop” approach in which observations of optical and/or electrical measurements drive the mechanical alignment between the optical waveguide 14 and an external coupler, such as a single-mode optical fiber.

However, while active alignment can be used to obtain sufficiently accurate alignment between external couplers and corresponding optical waveguides 14 in dies 10, active alignment has several disadvantages. For example, active alignment can be time consuming, depending of course upon the sophistication of the manufacturing system(s) used to vary and fix the alignment and to measure insertion loss or other alignment parameters, for error signal feedback into the alignment process. Further, active alignment systems can be expensive, particularly if they are designed for high-speed/high-volume coupling operations.

### SUMMARY

This disclosure teaches an optical transposer that provides “passive” alignment between optical waveguides in a silicon photonics die seated within a receptacle that is formed in a body member of the optical transposer and corresponding optical waveguides that are precisely dimensioned and located within the body member via laser scribing. The manufacturing method and optical transposer configuration taught herein allow for essentially automated placement (e.g., seating and gluing) of silicon photonics dies within corresponding optical transposer receptacles, without need for controlling final die alignment/placement as a function of measured optical insertion loss. In particular, such passive alignment is obtained via accurate dimensioning of the receptacles relative to the dies and by precise positioning of the entry points into the receptacles of the optical waveguides that are laser scribed into the body member of the optical transposer.

In an example embodiment, the contemplated optical transposer comprises a body member that is configured as a carrier for a silicon photonics die that has an optical waveguide positioned along a die edge. The body member includes a laser-scribed optical waveguide that opens into an interior face of a receptacle that is formed within the body member. The receptacle is dimensioned to receive and passively align the optical waveguide of the silicon photonics die with the optical waveguide of the optical transposer.

In a corresponding example, the contemplated manufacturing method includes forming a receptacle within a body member of an optical transposer. The forming operation includes dimensioning the receptacle to receive a silicon photonics die in optical alignment with an optical waveguide of the optical transposer, which opens into an interior face of the receptacle. That is, the optical waveguide of the optical transposer is fabricated so that one end of it opens into the receptacle at a location that aligns with the optical waveguide of the silicon photonics die, when the die is seated in the receptacle. Laser scribing is used to form at least a portion of the optical waveguide of the optical transposer into the body member, to achieve precise dimensioning and position and/or to reduce manufacturing time and expense.

Of course, the present invention is not limited to the above features and advantages. Indeed, those skilled in the art will recognize additional features and advantages upon reading the following detailed description of example embodiments, and upon viewing the accompanying drawings.

### BRIEF DESCRIPTION OF THE DRAWINGS

FIG. 1 is a diagram of a known silicon photonics die arrangement, illustrating an optical waveguide along an exterior edge of the die.

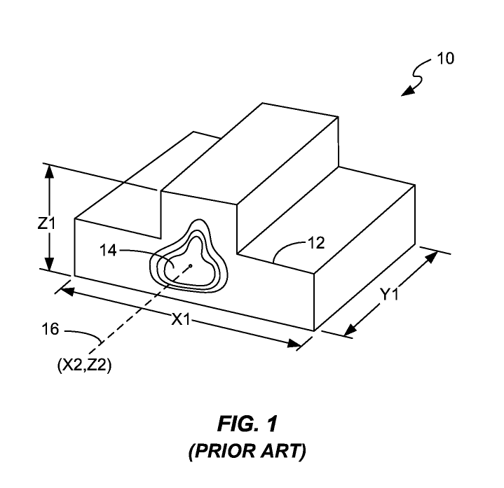

FIG. 2 is a diagram of one embodiment of an optical transposer as taught herein, which advantageously serves as a carrier for a silicon photonics die and provides passive alignment between the optical waveguides in the die and the optical waveguides in the optical transposer, which are precisely positioned and dimensioned within a body member of the optical transposer using laser scribing.

FIG. 3 is a logic flow diagram of one method of manufacturing an optical transposer, as contemplated herein.

FIG. 4 is a diagram of other embodiments of the optical transposer, as used in context with a modular circuit assembly.

FIG. 5 is a diagram of example details for changing a pitch (spacing) of optical interconnects using an embodiment of the optical transposer contemplated herein.

FIGS. 6A and 6B are diagrams of further example details, wherein electrical contacts are integrated into a receptacle of an optical transposer, for electrically contacting corresponding electrical contacts of a silicon photonics die.

FIG. 7 is a diagram of further example manufacturing details for an optical waveguide feature that is at least partially formed in an optical transposer via laser scribing.

### DETAILED DESCRIPTION

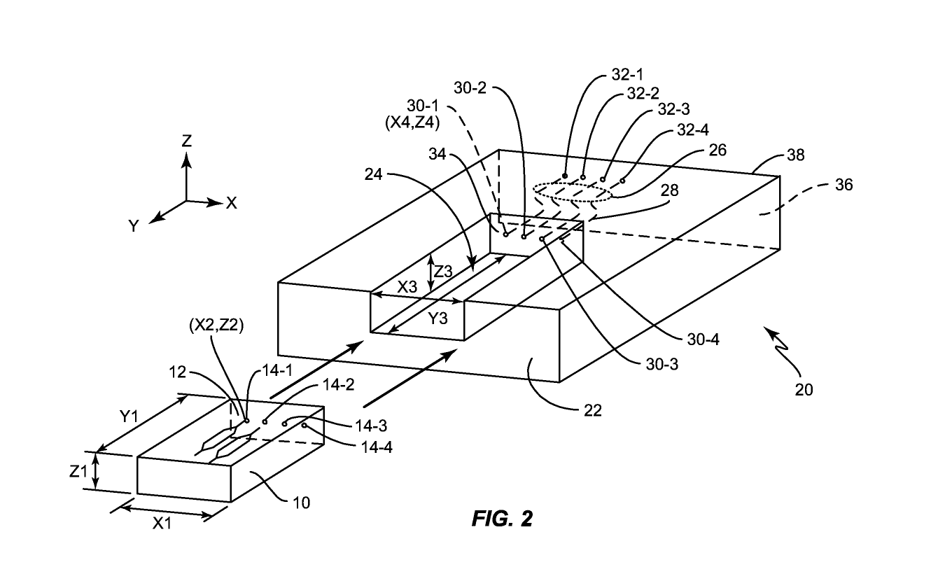

FIG. 2 depicts one embodiment of an optical transposer 20, as contemplated herein. The term “transposer” will be understood as denoting a carrier for one or more silicon photonics dies 10 (“die 10” or “dies 10”), wherein that carrier has the properties, features, and advantages detailed by way of example herein.

In the illustrated example, the die 10 has body dimensions of X1, Y1, and Z1, and has multiple optical waveguides 14, e.g., 14-1, 14-2, and so on, which are exposed within an exterior face running along the edge 12 of the die 10. The reference number “14” will be used in the singular and plural senses without any suffixing, unless suffixes aid clarity.

The optical transposer 20 in the illustrated example comprises a body member 22 that is configured as a carrier for the die 10, which, as noted, has a number of optical waveguides 14 positioned along a die edge 12. The body member 22 includes a set 26 of laser-scribed optical waveguides 28 opening into an interior face 34 of a receptacle 24 that is formed within the body member 22. The receptacle 24 is dimensioned to receive the die 10 into a seated position within the receptacle 24 and thereby passively align each optical waveguide 14 of the die 10 with a corresponding one of the optical waveguides 28, which are formed into the body member 22 of the optical transposer 20 and which open into the receptacle 24 at precisely located points corresponding to the locations of the optical waveguides 14 of the die 10 in its seated position.

In at least some embodiments, the body member 22 is a silicon-based glass material and the optical waveguides 28 are formed within that material. By way of non-limiting example, in at least one such embodiment the body member 22 is made from one of: Silicon Oxinitride (SiOₓN_{y}), Germanium Dioxide (GeO₂), or doped Silicon Dioxide (SiO₂).

In any case, the body member 22 is made of a material possessing suitable physical, thermal, optical and electrical properties. In particular, the body member material should provide for precise machining, molding, or other formation of the receptacle 24, to provide for precise matching with the X1, Y1, Z1 dimensions of the die 10. That is, the corresponding X3, Y3, Z3 dimensions of the receptacle 24 are sized to provide a precise seating of the die 10 within the receptacle 24, so that each optical waveguide 14 of the die 10 passively aligns with a corresponding optical waveguide 28 of the optical transposer 20, when the die 10 is seated within the receptacle 24.

For example, in one embodiment, the nominal X3, Y3 and Z3 dimensions of the receptacle 24 are set a few percent larger than the nominal X1, Y1, Z1 dimensions of the die 10. It is also contemplated to make allowances, e.g., in the X3 and/or Z3 dimensions, to accommodate bonding material, such as a thin layer of low-viscosity glue. Of course, other variations are contemplated. For example, the Z3 dimension can be appreciably larger than the maximum Z1 dimension of the die 10—i.e., the receptacle 24 can be deeper than the die 10 is tall—and a lid or other retaining element can be fixed into place over the receptacle 24, to hold the die 10 in position within the receptacle 24. Similarly, the Y3 dimension can be appreciably larger than the Y1 dimension, thus allowing the die 10 to be slid into or otherwise seated all the way forward into the receptacle 24, with a back-end retainer or bonding material used within the open receptacle space afforded by the Y3−Y1 difference.

Moreover, the coefficient of thermal expansion and/or other thermal properties of the optical transposer 20 should be suitable for the contemplated application. Preferably, the optical transposer 20 will be made from a material that is relatively insensitive to temperature, in terms of thermal expansion, and the material will be relatively well matched to the thermal expansion characteristics of the die 10.

A key aspect is that the body member 22 includes one or more optical waveguides 28 formed therein. Each optical waveguide 28 opens into the receptacle 24 and precisely aligns with a corresponding optical waveguide 14 of the die 10, when the die 10 is seated in the receptacle 24. A laser-scribing process is used to precisely form at least a portion of each optical waveguide 28, to insure precision alignment with the corresponding optical waveguide 14 of the die 10.

Laser scribing is cheaper and more efficient than the active alignment mentioned in earlier herein. On the other hand, while laser scribing is more time consuming and expensive than photolithography etching for large volume manufacturing, it offers the precision of active alignment at lower cost and with more flexibility, including post-processing. One aspect of such flexibility flows from the fact that optical transposer 20 can be understood as decoupling the die 10 from the details of final fiber or other interconnect coupling. Further, laser scribing allows for the formation of waveguide structures in bulk material, which would not be possible with etching.

For example, laser scribing can be used to form the terminal portion of each optical waveguide 28 where it opens into the receptacle 24, for precise alignment. In another example, laser scribing is used to form longer portions of an overall optical waveguide 28 within the body member 22, e.g., to save manufacturing time and because laser scribing allows precision at the junction between a preformed section of optical waveguide 28 and a laser-scribed portion of the same optical waveguide 28.

In the example of FIG. 2, one can see that the die 10 has four optical waveguides 14-1, 14-2, 14-3 and 14-4. Correspondingly, the body member 22 of the optical transposer 20 includes a set 26 of four optical waveguides 28. Each optical waveguide 28 includes a first end 30 and a second end 32. That is, a first one of the optical waveguides 28 has opposing ends 30-1 and 32-1, a second one of the optical waveguides 28 has opposing ends 30-2 and 32-2, and so on.

The first end 30 of each optical waveguide 28 opens into an interior face 34 of the receptacle 24 at a location that aligns with a corresponding one of the optical waveguides 14 of the die 10, when the die 10 is seated in the receptacle 24. That is, each first end 30 is located at a position (X4, Z4) on the interior face 34 of the receptacle 24 that precisely aligns with a corresponding one of the optical waveguides 14 of the die 10, when the die 10 is properly seated within the receptacle 24.

Accurate alignment between the first ends 30 of the optical waveguides 28 and respective ones of the optical waveguides 14 in a seated die 10 is obtained in at least some embodiments by laser-scribing of the first end 30 of each optical waveguide 28 within the interior face 34 of the receptacle 24 and by accurate dimensioning of the receptacle 24. This arrangement “automatically” yields sufficiently precise optical alignment between the optical waveguides 14 of the die 10 and the corresponding first ends 30 of the optical waveguides 28 of the optical transposer 20, upon proper seating of the die 10 within the receptacle 24.

Here, “proper seating” means that the die 10 is seated within the receptacle 24 so that its edgewise face along the exterior edge 12 (which face carries the optical waveguides 14) engages with or otherwise abuts the interior face 34 of the receptacle 24, which includes the first ends 30 of the optical waveguides 28. Equivalently, it is contemplated that the die 10 may have additional or alternative exit points for its optical waveguides 14 on its bottom surface relative to the receptacle 24. In such a case, the optical waveguides 28 of the optical transposer 20 are formed in corresponding positions in the seating surface of the receptacle 24. Thus, the terms “edge” and “face” as used herein to refer to the die 10 and the body member 22 should be given a broad construction, and may be referring to any surface of the die 10 and any corresponding engaging surface in the receptacle 24, where such surfaces may be horizontal, vertical, etc.

Continuing with the example of FIG. 2, the second end 32 of each optical waveguide 28 of the transposer 20 opens into an exterior face 36 along an exterior edge 38 of the body member 22. In an advantageous but non-limiting example embodiment, each such second end 32 is configured to receive an optical fiber. Such an arrangement provides convenient termination of an optical fiber at the second end 32 of each optical waveguide 28. An optical fiber is thus placed into alignment with an optical waveguide 14 of the die 10 by virtue of connecting it to the terminal end 32 of a respective one of the optical waveguides 28 of the optical transposer 20.

In one or more embodiments, the die 10 includes a plurality of optical waveguides 14 along a die edge 12, and the body member 22 of the optical transposer 20 includes a plurality of optical waveguides 28, each opening into the interior face 34 of the receptacle 24. Each such optical waveguide 28 aligns with a respective one of the optical waveguides 14 of the die 10, when the die 10 is seated within the receptacle 24.

As a further option, the optical transposer 20 may be used to change the pitch or geometry used for optically coupling with the plurality of optical waveguides 14 of the die 10. For example, the first ends 30 of the plurality of optical waveguides 28 formed in the body member 22 open into the receptacle 24 at a first spacing—which spacing is dictated by the spacing of the optical waveguides 14 of the die 10. However, the second ends 32 of the plurality of optical waveguides 28 formed in the body member 22 open into a second receptacle 24 (not shown in FIG. 2) in the body member 22, or into an exterior face 36 of the body member 22, at a second spacing that is greater than the first spacing. Of course, it should be understood that other relationships can be configured between the first spacing and the second spacing.

Equivalently, the geometry, arrangement, and/or order of the second ends 32 may differ from that of the first ends 30, which must be arranged according to the arrangement of optical waveguides 14 in the die 10. Those skilled in the art will appreciate the potential advantages gained by expanding the pitch and/or geometry between the second ends 32, as compared to that used for the first ends 30, in terms of simplifying connections to external couplers, such as multiple optical fibers, etc. In an example arrangement, the second ends 32 are arranged in a geometry corresponding to a multi-core fiber, to thereby transmit or receive differing optical signals on different fiber cores to or from different ones of the optical waveguides 14 in the die 10.

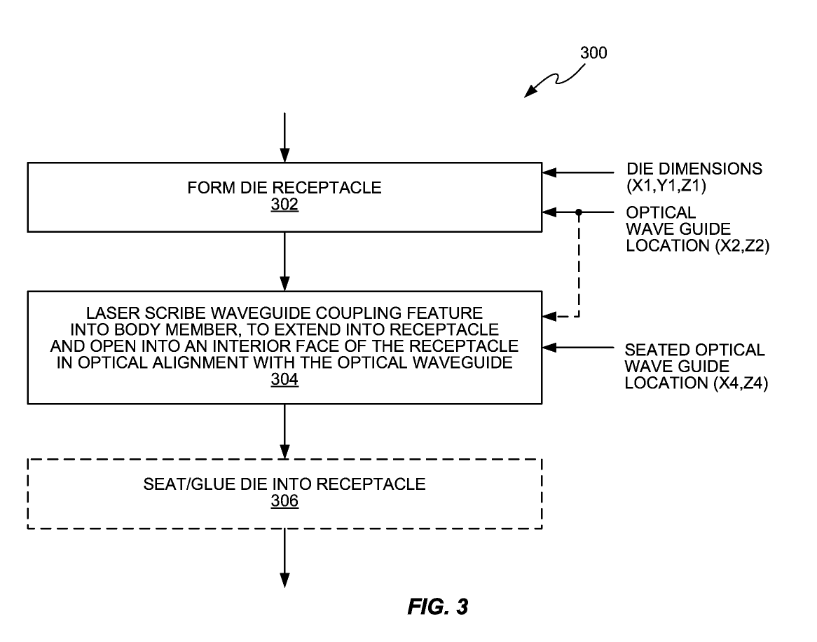

With the above in mind, FIG. 3 illustrates an example method 300 of manufacturing the contemplated optical transposer 20. The method 300 includes forming the (die) receptacle 24 in the body member 22 (Block 302). In an example case, the receptacle 24 is machined into the body member 22. However formed, key manufacturing control variable inputs to this step include, e.g., the nominal die dimensions (X1, Y1, Z1). The position (X2, Z2) of each optical waveguide 14 provided by the die 10 also may be provided as an input.

As noted before, the receptacle 24 may be formed or otherwise constructed to include certain additional features, such as die and/or alignment retaining features, and adhesive control features such as dams or drainage channels. For example, the floor of the receptacle 24 may be finely grooved to permit the outflow of excess glue, to prevent the die 10 from floating on a layer of adhesive and becoming vertically misaligned relative to the optical waveguide(s) 28 in the interior face 34 of the receptacle 24 during the die seating process.

The method 300 further includes a laser-scribing process, to form all or part of the optical waveguides 28 in the body member 22 (Block 304). In particular, in at least one embodiment, laser scribing is used to precisely locate the first end 30 of each optical waveguide 28 within the interior face 34 of the receptacle 24. Thus, the critical alignment point of each optical waveguide 14, as projected onto the interior face 34 of the die 10 when it is seated in the receptacle 34, is provided as an input to this process.

These points are denoted as the (X4, Z4) locations and they represent the locations at which the first ends 30 of the optical waveguides 28 will be laser scribed into the interior face 34 of the receptacle 24. Each (X4, Z4) position can be determined, within applicable manufacturing tolerances, from the (X2, Z2) location known for each optical waveguide 14 provided by the die 14, along with a delta Z value associated with glue, etc., bearing on the final seated height of the die 10.

The method 300 may further include seating and/or gluing of the die 10 into the receptacle 24 (Block 306). However, these operations are not necessarily part of the contemplated method 300, as optical transposers 20 may be made in advance, for a specific type/style of die 10, and sold separately to a downstream manufacturer or module fabricator who provides the dies 10 and performs the die seating operation, e.g., as part of fabricating a larger assembly. In this regard, different models and configurations of optical transposers 20 are contemplated, for a range of die types, sizes, and configurations. It is also contemplated to provide different coupling solutions via different models of optical transposers 20. For example, some models may be tailored for termination of optical fibers, while others may target System-on-a-chip or multi-chip module applications. Still others may provide a hybrid of these two targeted applications.

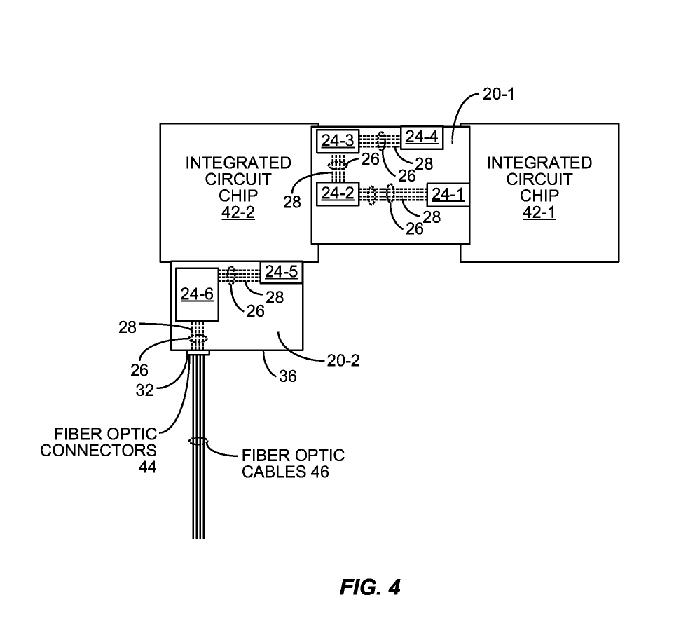

FIG. 4 illustrates examples of such variations of the optical transposer 20. In particular, one sees a multi-chip module substrate 40 carrying a pair of integrated circuits 42-1 and 42-2. A first optical transposer 20-1 provides an electro-optical interface between the two integrated circuits 42 by providing a first receptacle 24-1 that provides electrical connections (not visible in the diagram) to the first integrated circuit 42-1 and provides optical coupling to a second receptacle 24-2 via a set 26 of waveguides 28.

Thus, in at least one embodiment, the optical transposer 20 further includes a second receptacle 24 formed within the body member 22 and dimensioned to receive a die 10 having one or more second optical waveguides 14 positioned along a die edge 12. The optical waveguides 28 have their first ends 30 opening into the first receptacle 24 and their second ends opening into an interior face 34 of the second receptacle 24, in alignment with the one or more second optical waveguides 14. This arrangement thereby provides optical paths between the first optical waveguides 14 of the first die 10 and the second optical waveguides 14 of the second die 10, when the dies 10 are seated in their respective first and second receptacles 24.

As a further example configuration, and as shown in the figure, the second receptacle 24-2 is optically coupled to a third receptacle 24-3 via another set 26 of waveguides 28. Either or both of the second and third receptacles 24-2 and 24-3 may electrically couple to the second integrated circuit 42-2, thus completing the bridging of the second integrated circuit 42-2 to the first integrated circuit 42-1. The third receptacle 24-3 may further couple to a fourth receptacle 24-4 via yet another set 26 of waveguides 28.

Notably, the different receptacles 24 of the first optical transposer 20-1 may be configured for different types of dies 10—i.e., one optical transposer 20 can carry more than one type of die 10. A given receptacle 24 is “configured” for a particular type or style of die 10 by virtue of its (X3, Y3, Z3) dimensioning and by the number and positioning of waveguides 28 opening into the receptacle 24.

FIG. 4 further depicts a second optical transposer 20-2 that includes two receptacles 24-5 and 24-6, one or both of which include electrical interconnections for connecting to the second integrated circuit 42-2. Moreover, the two receptacles 24-5 and 24-6 are optically coupled via a set 26 of waveguides 28, and the receptacle 24-6 includes a further set of waveguides 28 whose second ends 32 open on an exterior face 36 of the optical transposer 20-2. Advantageously, these second ends 32 are configured with fiber optic connectors 44 for terminating fiber optic cables 46.

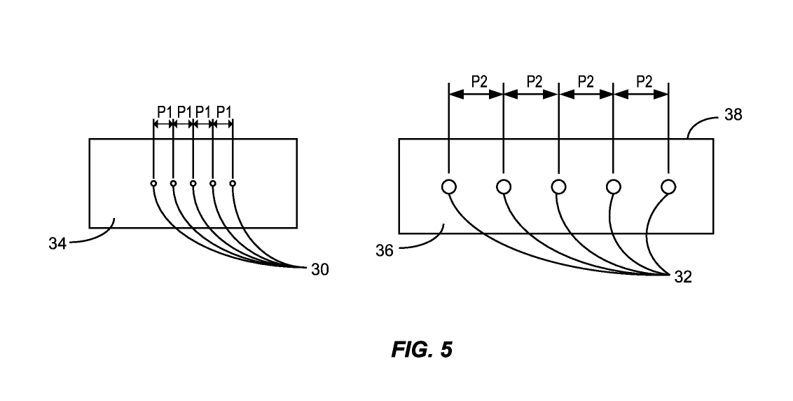

It will be appreciated that the die 10 intended for the receptacle 24-6 includes optical waveguides 14 facing the optical waveguides 28 between the receptacle 24-6 and the receptacle 24-5, and optical waveguides 14 facing the optical waveguides 28 that terminate on the exterior face 36 of the optical transposer 24-6. Further, as illustrated in FIG. 5, the optical waveguides 28 that extend from the receptacle 24-6 to the exterior face 36 of the optical transposer 20-2 may change pitch from their first ends 30 to their second ends 32.

This arrangement allows, for example, changing from a pitch “P1” between optical waveguides 14 on a die 10 to a pitch “P2” between fiber optic connectors 44 or other external coupler arrangements adapted for termination on the exterior face 36 of the body member 22 of the optical transposer 20-2. Of course, the ability to change pitch between respective ends of a set 26 of waveguides 28 may be used anywhere needed, e.g., to optically interconnect a first die 10 in a first receptacle 24 with a second die 10 in a second receptacle 24, where the two dies 10 use different pitches between the two or more optical waveguides 14 provided by each die 10.

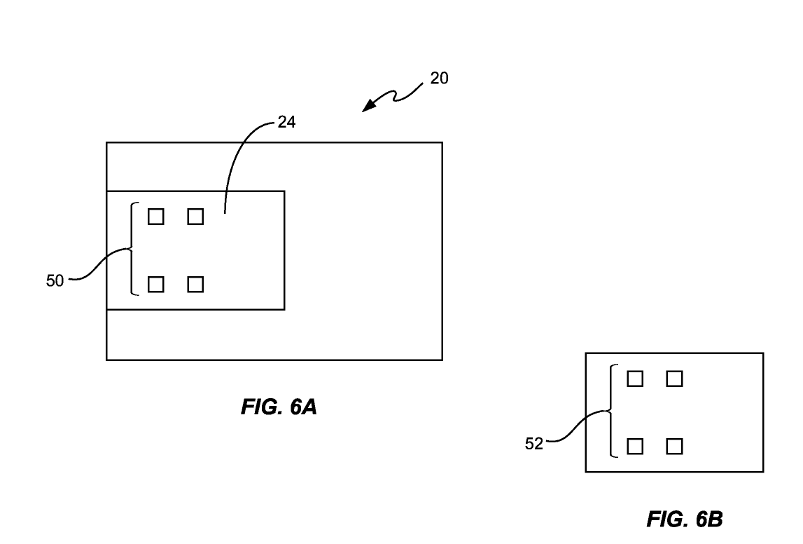

Similar flexibility may be used regarding electrical interconnections. As shown in FIG. 6A, a given receptacle 24 may include electrical contacts 50 that are configured to engage corresponding electrical contacts 52 (shown in the die bottom view of FIG. 6B) of the silicon photonics die 10, when the silicon photonics die 10 is seated within the receptacle 24. The electrical contacts 50 in the receptacle 24 may extend through the body member 22, e.g., for electrically contacting corresponding contacts on a substrate or other carrier on which the optical transposer 20 is mounted. Alternatively, the optical transposer 20 may be configured with a first set of electrical contacts for external connections, and those contacts may be wired or otherwise electrically coupled to the contacts 50 within the receptacle 24.

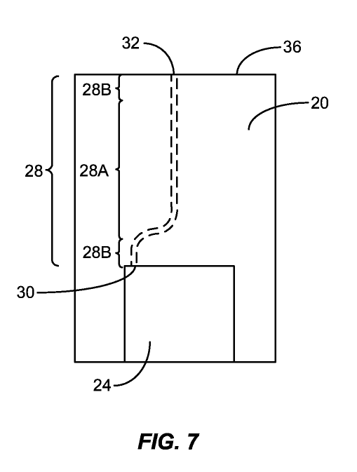

As a further point of manufacturing flexibility and/or efficiency, it is contemplated herein that laser-scribing be used for forming less than all of a given waveguide 28. For example, FIG. 7 depicts a top view of an example optical transposer 20, wherein one or more portions 28A of a waveguide 28 are fabricated using a manufacturing process other than laser scribing, e.g., a process that may be cheaper or simpler but perhaps less precise. In an example embodiment, the portion(s) 28A are fabricated using photolithography.

However, one or more key portions 28B of the optical waveguide 28 are fabricated using laser scribing, to obtain the precise dimensioning available with that manufacturing process. In particular, a terminal portion of the optical waveguide 28 that ends in the first opening 30 into the receptacle 24 is laser scribed, to obtain the precise dimensioning and accurate positioning of that first opening 30 with respect to a corresponding optical waveguide 14 of a die 10, when the die 10 is seated in the receptacle 14. Similarly, the terminal portion of the optical waveguide 28 that ends in the second opening 32 also may be laser scribed.

As for the laser scribing system used in forming all or portions of the optical waveguides 28, commercial laser scribing systems are known. Further, as is known, the characteristics of the laser beam itself should be targeted to the particular material type used for the body member 22. Selectable parameters for the laser include any one or more of: beam width, beam shape, laser wavelength, laser power, and laser pulse rate. The laser may be a diode-pumped solid-state (DPSS) laser, in which the pulse repetition rate, pulse width, laser wavelength, and beam power are tailored for micro-machining the type of material selected for the body member 22.

Use of laser scribing in the contemplated manner provides low cost, high-volume passive alignment of Si-photonics dies to other such dies and or to optical fibers or other external optical couplers. The laser scribing process offers this precision while at the same time being much simpler than other known technologies and laser scribing has no implicit thermal or polarization dependence. Also, as waveguides 28 can be laser-scribed in any direction on the body member 22 of the contemplated optical transposer 20, it is contemplated herein to retrofit Si-photonics dies that use grating couplers, for example, to offer a superior coupling solution as compared to fiber-to-grating coupling, while obviating the need for new spin of the die. Such an approach has the potential to save significant money because it avoids the need for die redesign and a corresponding new CMOS (complementary metal oxide semiconductor) mask fabrication.

Further, the optical transposer 20 offers great flexibility at the optical fiber interface point, and does so at a lower cost than spinning a different CMOS layout for different coupling patterns. Thus, the optical waveguides 14 of a given die 10 could come to the edge 12 of the die 10 and be coupled to the optical waveguides 28 of the optical transposer 20 in a parallel fashion and either keep the channels parallel or arrange them, e.g., in a desired multicore fiber pattern, or other pattern.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-19. (canceled)

20. An optical transposer comprising:
a body member configured as a carrier for a silicon photonics die that has an optical waveguide positioned along a die edge;
said body member including a laser-scribed optical waveguide opening into an interior face of a receptacle formed within the body member; and
said receptacle dimensioned to receive and passively align the optical waveguide of the silicon photonics die with the optical waveguide of the optical transposer.

21. The optical transposer of claim 20, wherein the body member is a silicon-based glass material.

22. The optical transposer of claim 21, wherein the body member is made from one of: Silicon Oxinitride, Germanium Dioxide, or doped Silicon Dioxide.

23. The optical transposer of claim 20, wherein the receptacle further includes electrical contacts configured to engage corresponding electrical contacts of the silicon photonics die, when the silicon photonics die is seated within the receptacle.

24. The optical transposer of claim 20, further comprising:
a second receptacle formed within the body member and dimensioned to receive a second silicon photonics die that has a second optical waveguide positioned along a die edge; and
wherein the optical waveguide of the optical transposer opens into an interior face of the second receptacle, in alignment with the second optical waveguide, thereby providing an optical path between the first and second optical waveguides of the first and second silicon photonics dies, when the first and second silicon photonics dies are seated within the first and second receptacles, respectively.

25. The optical transposer of claim 20, wherein a first end of the optical waveguide of the optical transposer opens into the interior face of the receptacle in alignment with the optical waveguide of the silicon photonics die, when the silicon photonics die is seated in the receptacle, and wherein a second end of the optical waveguide of the optical transposer opens into an exterior face of the body member, and wherein the second end of the optical waveguide of the optical transposer is configured to receive an optical fiber.

26. The optical transposer of claim 20, wherein the silicon photonics die includes a plurality of optical waveguides along the die edge, and further wherein the optical waveguide of the optical transposer comprises one among a plurality of optical waveguides of the optical transposer, each optical waveguide of the optical transposer opening into the interior face of the receptacle and aligning with a respective one of the optical waveguides of the silicon photonics die, when the silicon photonics die is seated within the receptacle.

27. The optical transposer of claim 26, wherein first ends of the plurality of optical waveguides of the optical transposer open into the receptacle at a first spacing, and wherein second ends of the plurality of optical waveguides of the optical transposer open into a second receptacle formed within the body member or into an exterior face of the body member, at a second spacing that is greater than the first spacing.

28. The optical transposer of claim 26, wherein first ends of the plurality of optical waveguides of the optical transposer open into the receptacle at a first geometry corresponding to a geometry of the plurality of optical waveguides of the silicon photonics die, and wherein second ends of the plurality of optical waveguides of the optical transposer open into an exterior face of the body member at a second geometry corresponding to a multi-core optical fiber.

29. A method of manufacturing an optical transposer for a silicon photonics die that has an optical waveguide along a die edge, said method comprising:
forming a receptacle within a body member of the optical transposer, including dimensioning the receptacle to receive the silicon photonics die in optical alignment with an optical waveguide of the optical transposer that opens into an interior face of the receptacle; and
laser scribing said optical waveguide of the optical transposer into the body member.

30. The method of claim 29, wherein laser scribing the optical waveguide of the optical transposer into the body member comprises forming a first part of the optical waveguide using photolithography processing and forming a second part of the optical waveguide using said laser scribing, said second part comprising a continuation of said first part.

31. The method of claim 29, further comprising seating the silicon photonics die into the receptacle and gluing the silicon photonics die into place, to thereby maintain the optical alignment between the optical waveguide of the silicon photonics die and the optical waveguide of the optical transposer.

32. The method of claim 29, further comprising integrating electrical contacts within the receptacle to engage corresponding electrical contacts of the silicon photonics die, when the silicon photonics die is seated within the receptacle.

33. The method of claim 29, further comprising:
forming a second receptacle formed within the body member that is dimensioned to receive a second silicon photonics die that has a second optical waveguide positioned along a die edge; and
laser scribing the optical waveguide of the optical transposer to extend into the second receptacle and open into an interior face of the second receptacle in alignment with the second optical waveguide, thereby providing an optical path between the first and second optical waveguides of the first and second silicon photonics dies, when the first and second silicon photonics dies are seated within the first and second receptacles, respectively.

34. The method of claim 33, further comprising integrating second electrical contacts into the second receptacle, to engage with corresponding electrical contacts of the second silicon photonics die, when the second silicon photonics die is seated in the second receptacle.

35. The method of claim 29, wherein a first end of the optical waveguide of the optical transposer opens into the interior face of the receptacle in optical alignment with the optical waveguide of the silicon photonics die, when the silicon photonics die is seated in the receptacle, and wherein the optical waveguide of the optical transposer extends outward from the receptacle and terminates at a second end that opens into an exterior face of the body member along an exterior edge of the body member, and wherein the method further comprises configuring the second end of the optical waveguide of the optical transposer to couple with optical fiber.

36. The method of claim 29, wherein the silicon photonics die includes a plurality of optical waveguides along the die edge, and wherein the method includes laser scribing a plurality of optical waveguides in the body member of the optical transposer, each opening into the interior face of the receptacle in optical alignment with a respective one among the plurality of optical waveguides of the silicon photonics die, when the silicon photonics die is seated in the receptacle.

37. The method of claim 36, further comprising forming the optical waveguides of the optical transposer to have first ends that open into the receptacle at a first spacing that corresponds to a spacing of the plurality of optical waveguides of the silicon photonics die, and to have second ends that open into another receptacle formed within the body member or into an exterior face of the body member at a second spacing that is greater than the first spacing.

38. The method of claim 36, further comprising forming the optical waveguides of the optical transposer to have first ends that open into the receptacle at a first geometry corresponding to a geometry of the plurality of optical waveguides of the silicon photonics die, and to have second ends that open into an exterior face of the body member at a second geometry corresponding to a multi-core optical fiber.
